(19) United States
(12) Patent Application Publication
(10) Pub. No.: US 2019/0046415 A1
(43) Pub. Date: Feb. 14, 2019

(54) BABY BOTTLE WITH INTEGRATED PACIFIER APPARATUS AND METHOD OF USE

(71) Applicant: Dustyn Zicafoose, Sebring, FL (US)

(72) Inventor: Dustyn Zicafoose, Sebring, FL (US)

(21) Appl. No.: 15/671,637

(22) Filed: Aug. 8, 2017

(51) Int. Cl. A61J 11/00; A61J 11/04; A61J 17/00

(52) U.S. Cl. CPC A61J 11/0075; A61J 17/001; A61J 11/04; A61J 11/002

(57) ABSTRACT

Embodiments described herein include a baby bottle with integrated pacifier apparatus and method of use including a substantially elongated baby bottle and nipple mounted assembly which includes a pressure valve mechanism configured to regulate the flow of liquid through the nipple and prevent excess air from being ingested.

### CROSS-REFERENCE TO RELATED APPLICATION

n/a

### STATEMENT REGARDING FEDERALLY SPONSORED RESEARCH OR DEVELOPMENT

n/a

### FIELD

The present embodiment relates to a baby bottle with integrated pacifier apparatus for improving nursing, and in particular, an apparatus and method for integrated pacifier apparatus and method allowing a user to conveniently transition between a nursing bottle and pacifier.

### BACKGROUND

Currently nursing bottles and nipples come in a variety of sizes by primarily using the traditional threads to attach the nursing bottle and nipple mount. These traditional designs ensure that liquid is not lost by having a “leaky seal”, and it creates a “user friendly” mounting system that makes cleaning a nursing bottle relatively easy.

At the same time nipples come in a variety of sizes, shapes, and contours which may be further customized to a baby's specific needs. However, regardless of these customizations, air molecules are able to enter the nursing bottle and nipple assembly. The air molecules ingested into the baby may cause bloating, burping, excessive gas, aerophagia, abdominal pain, and colic which, ultimately, disturbs the baby's sleep throughout the night.

The most popular method to prevent excessive air from ingesting into the baby is to remove the nursing bottle altogether and simply insert a pacifier into the baby's mouth. However, when the baby is asleep or mildly uncomfortable, removal of the nursing bottle can be tedious and often upsets the baby, or even leads to further ingestion.

These feedings, transitions, and air ingestion difficulties must be further considered by the optimal posture of the baby when attempting to transition between the above listed evolutions. For example, if the baby is asleep on his/her stomach it is nearly impossible to insert/remove a nursing bottle. Conversely, if the baby is asleep on the bottle it becomes increasing difficult to transition from a nursing bottle to a pacifier while maintaining a balance of both objects in a single movement.

There are currently several references associated with baby bottles that transition to pacifiers as U.S. Pat. No. 4,898,291, U.S. Pat. No. 4,640,424, and U.S. Pat. No 5,791,503. However, these references fail to provide a “hands free” catch and release assembly system that enables the user to quickly transition from the nursing bottle to the pacifier in a single motion. This limited movement does not disturb a sleeping baby and minimizes air ingestion ensuring both the baby and parent get a more restful night.

Therefore, there is an immediate need for a nursing bottle with integrated pacifier that decreases air ingestion and provides a transition method that is less disruptive to the baby and parent.

### SUMMARY OF THE INVENTION

Embodiments described herein include a baby bottle with integrated pacifier and methods of use. The current embodiment is comprised of a substantially elongated baby bottle with a releasably, securable nipple. The nipple further includes an integrated pacifier that allows a user to transition from a bottle to pacifier with a single hand by simply utilizing a valve system.

The advantage of the current embodiment includes the ability to isolate the pacifier from the nursing bottle by utilizing a pressure valve that enables the user to transition from the bottle to the pacifier by depressing the nipple mount assembly and actuating the internal pressure valve. Further benefits include reducing the baby's air ingestion, and providing an apparatus allowing parents to conveniently convert a nursing bottle to a pacifier while operating the apparatus without disturbing the baby.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a perspective view of a baby bottle with integrated pacifier apparatus;

FIG. 2A is a view of the nipple mount assembly with integrated pacifier in the closed position; and

FIG. 2B is a view of the nipple mount assembly with integrated pacifier in the open position.

### DETAILED DESCRIPTION

As used herein, relational terms, such as “first” and “second,” “top” and “bottom,” and the like, may be used solely to distinguish one entity or element from another entity or element without necessarily requiring or implying any physical or logical relationship or order between such entities or elements.

The present embodiment relates to a baby bottle with integrated pacifier apparatus and method of use. The current embodiment provides an apparatus that may be easily transitioned from a nursing bottle to a pacifier to prevent excessive ingestion of air and ensure the baby has a restful sleep without being agitated by the continuous transition of nursing bottle to pacifier. Specifically, the current embodiment includes a nipple mount mechanism with a catch release system button that allows the parent to simple depress a button to remove the nipple for cleaning and disinfecting and allows the bottle to transition from a bottle to pacifier by turning a valve lever.

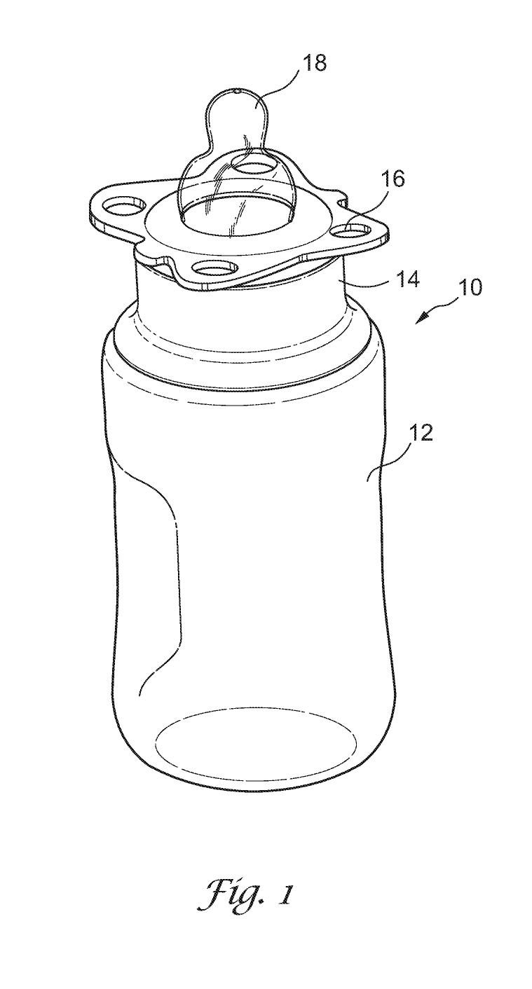

Referring now to the drawings wherein like reference numerals designate identical or corresponding parts throughout the views, there is shown in FIG. 1 one embodiment a baby bottle with integrated pacifier apparatus 10 (herein known as “apparatus”). The apparatus 10 further includes a nursing bottle (herein known as “bottle”) 12 that is substantially elongated and cylindrical to contain a volume of liquid. Releasably attached to the bottle 12 is nipple assembly mount 14 that functions to allow a user to transition from a mechanism that disperse liquid to a pacifier system while minimizes the ingestion of excess air to the baby. The nipple mount assembly 14 further includes at least a nipple assembly opening 16 to allow a user to further grip the apparatus 10 at night or attached the apparatus 10 to plurality of baby accessories. The nipple mount assembly 14 includes a nipple/integrated pacifier (herein known as “nipple”) 18 that is designed to mimic the mother's breast during breastfeed and never collapse while baby is drinking therefrom. The nipple 18 may further be comprised of at least a host of BPA-free, PVC-free, and lead-free materials.

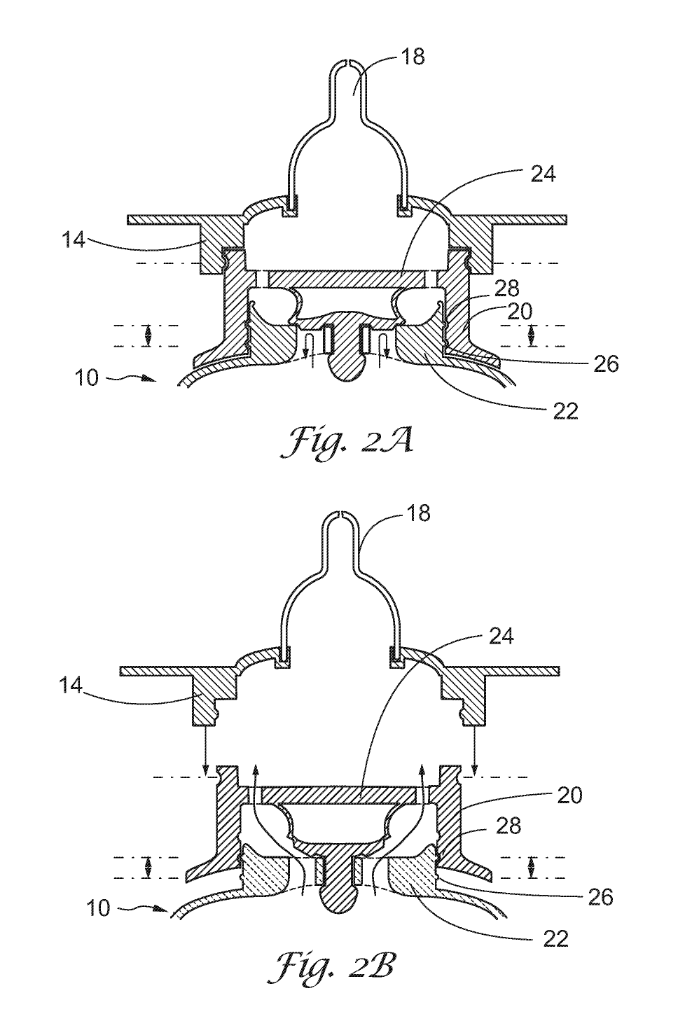

Shown in FIG. 2A the apparatus 10 in the closed position with nipple mount assembly 14 attached to the bottle 12 via the apparatus mating mechanism 20 that is releasably secured to the bottle wall 22 to prevent the apparatus 10 from leaking fluid while being operated. Further the apparatus 10 is in closed position that allows the user to utilize the nipple 18 without the flow of liquid utilizing the pressure valve 24. The pressure is designed to regulate, direct, and control the flow of liquid from the bottle 12 and may constrict the flow of liquid when seated against the bottle wall 22. The pressure valve 24 is actuated when the nipple mount assembly 14 is attached to the bottle 12 and secured onto the apparatus mating mechanism 24 and the nipple mount assembly 14 is depressed thus mating the nipple mount assembly 114 onto the first mating notch 26.

Shown in FIG. 2B the apparatus 10 in the open position with the nipple mount assembly 14 extended for use as a bottle 12. The user may operate apparatus 10 in the open position by simply pulling the nipple mount assembly 14 until it is releasably mated onto the second mating notch 28. This pulling motion on the nipple mount assemble 14 “un-seats” the pressure valve from the bottle wall 22 allowing the liquid to flow to the nipple 18.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the following claims.

What is claimed is:

1. A baby bottle with integrated pacifier apparatus configured to enable a user to transition from a bottle to integrated pacifier with a single hand and without waking a sleeping baby, the apparatus comprising:
a baby bottle, the baby bottle with a first and second end; and
a nipple mount assembly, the nipple mount assembly configured to be secured to the first end of the baby bottle and contains a value mechanism configured to control the flow of liquid through the nipple assembly mount by depressing or releasing the nipple mount assembly.

2. The apparatus of claim 1, wherein the baby bottle is elongated and substantially round to allow the user to secure the nipple mount assembly onto the baby bottle.

3. The apparatus of claim 2, wherein the baby bottle includes a baby bottle mounting wall with a mating mechanism to allow the nipple mounted assembly to be releasably secured to the baby bottle mounting wall while configured in the open/closed position.

4. The apparatus of claim 1, wherein the valve mechanism is pressure value configured to be actuated by seating onto baby bottle mounting wall.

5. The apparatus of claim 3, wherein the valve mechanism may be secured in the open, closed and partial position by pulling on the nipple mount assembly to control the flow of a fluid.

6. The apparatus of claim 1, wherein the nipple mount assembly includes at least a pacifier, the pacifier having a hollowed region to allow the fluid to leave the nipple mounted assembly and prevent excess gas from being ingested.

7. A integrated baby bottle apparatus configured to enable a user to transition from a baby bottle to pacifier within a single mechanism, the apparatus comprising:
a baby bottle, the baby configured to retain fluid; and
a nipple mounted assembly dimensioned to be releasably attached to the baby bottle and configured to allow a user to transition to a pacifier by depressing on the nipple mounted assembly;

8. The integrated baby bottle apparatus of claim 12, wherein the nipple assembly mount includes an integrated pressure valve to regulate the flow of fluid through a pacifier.

9. The integrated baby bottle apparatus of claim 10, further comprising a cap that may be reliably coupled to the first end of the baby bottle by at least a attachment mechanism.

10. The integrated baby bottle apparatus of claim 12, wherein the nipple mount assembly includes at least a pressure valve to control the flow of fluid from the baby to a pacifier.

11. A method of operating a baby bottle with integrated pacifier apparatus, comprising:
coupling a nipple mounted assembly to the first end of a baby bottle such that the nipple assembly mounts forms an air tight seal and allows the user to transition from a bottle to pacifier; and
depressing/pulling on the nipple mounted assembly to control the flow of liquid to allow the fluid to flow through a valve assembly mechanism and out a pacifier to allow a user to select a bottle or pacifier and prevent excess air in the apparatus.
